(19) United States
(12) Patent Application Publication
(10) Pub. No.: US 2017/0254457 A1
(43) Pub. Date: Sep. 7, 2017

(54) HOSE CLAMP WITH MECHANICAL INDICATOR

(71) Applicants: Edwin T. Koehler, Smyrna, TN (US); Bruce D. Bowater, Franklin, TN (US); Michael K. Mckervey, Smyrna, TN (US); Steve Hemp, Smyrna, TN (US)

(72) Inventors: Edwin T. Koehler, Smyrna, TN (US); Bruce D. Bowater, Franklin, TN (US); Michael K. Mckervey, Smyrna, TN (US); Steve Hemp, Smyrna, TN (US)

(21) Appl. No.: 15/447,730

(22) Filed: Mar. 2, 2017

Related U.S. Application Data
(60) Provisional application No. 62/302,579, filed on Mar. 2, 2016.

(51) Int. Cl. F16L 33/04; F16L 35/00

(52) U.S. Cl. CPC F16L 33/04; F16L 35/00

(57) ABSTRACT

A hose clamp is disclosed. The hose clamp includes a mechanical indicator configured to fracture at a predetermined band tension.

### CROSS-REFERENCE TO RELATED APPLICATIONS

This application is a continuation of and claims priority to U.S. Provisional Patent Application Ser. No. 62/302,579, which was filed on Mar. 2, 2016 and is expressly incorporated herein by reference.

### BACKGROUND

The present disclosure relates to clamp designs and, more specifically, to a design for a hose clamp.

### TECHNICAL FIELD

Hose clamps are commonly utilized to join together hoses and fittings or connectors, for example, within the automotive industry. Hose clamps may include a liner that may be spot welded, riveted, or otherwise fastened to a circular outer band and a locking mechanism to couple the ends of the outer band together and apply tension to the clamp. A radial load may be created by the tension and may be transmitted to the fittings of the joint as a radial load. Examples of hose clamps are shown and described in U.S. Pat. Nos. 8,650,719; 8,677,571; and 7,302,741, which are incorporated herein by reference.

Hose clamps may be sold to companies that supply hose or duct sub-assemblies to the end user. These sub-assemblies typically include a hose substrate and one or more clamps. A typical hose clamp application targets a predetermined band tension that is determined empirically or theoretically to affect a seal on a hose/fitting assembly (joint). Band tension is a function of installation torque, bolt diameter, thread “K” factor, spring rate of the hose/joint, and friction between the clamp and the hose.

In many clamp designs, spring rate, friction, “K” factor, and bolt diameter are assumed to be constant such that the band tension is then directly proportional to installation torque. This assumed proportionality of band tension and installation torque has led many clamp users to target a pre-determined installation torque to generate the targeted band tension to affect the proper seal. This assumed proportionality is difficult to replicate during manufacturing, when typical manufacturing tolerances make it difficult to maintain the spring rate, friction, “K” factor, and bolt diameter constant.

### SUMMARY

According to one aspect of the disclosure, a hose clamp is disclosed. The hose clamp comprises an annular band, a tension mechanism configured to tighten the annular band to increase band tension, and a mechanical indicator configured to fracture at a predetermined band tension.

In some embodiments, the mechanical indicator may comprise a tooth connected to a spine. The tooth may be configured to fracture at the predetermined band tension.

In some embodiments, the mechanical indicator may comprise a fuse coupled to the spine, and the fuse may include the tooth.

In some embodiments, the tooth may be formed from a plastic material, and, in some embodiments, the annular band may be formed from a metallic material.

In some embodiments, the annular band may include the spine.

In some embodiments, the annular band may include a pair of spines. The tooth may extend between the pair of spines.

In some embodiments, the annular band may include the spine and the tooth.

In some embodiments, the predetermined band tension may be equal to about 800 lbs.

### BRIEF DESCRIPTION OF THE DRAWINGS

The detailed description particularly refers to the following figures, in which:

FIG. 1 is a perspective view illustrating one embodiment of a hose clamp including a mechanical indicator;

FIG. 2 is a perspective view illustrating another embodiment of a hose clamp including a mechanical indicator;

FIG. 3 is a perspective view illustrating another embodiment of a hose clamp including a mechanical indicator;

FIG. 4 is a perspective view illustrating another embodiment of a hose clamp including a mechanical indicator;

FIG. 5 is a partial perspective view of the clamp of FIG. 4 showing the mechanical indicator positioned under a shield;

FIG. 6 is a partial side elevation view of the clamp of FIGS. 4-5;

FIG. 7 is a perspective view illustrating another embodiment of a hose clamp including a mechanical indicator;

FIG. 8 is a partial perspective view illustrating the mechanical indicator of the hose clamp of FIG. 7;

FIG. 9 is a side elevation view illustrating the mechanical indicator of the hose clamp of FIGS. 7-8; and

FIG. 10 is another partial perspective view of the hose clamp of FIGS. 7-9.

### DETAILED DESCRIPTION OF THE DRAWINGS

While the concepts of the present disclosure are susceptible to various modifications and alternative forms, specific exemplary embodiments thereof have been illustrated by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

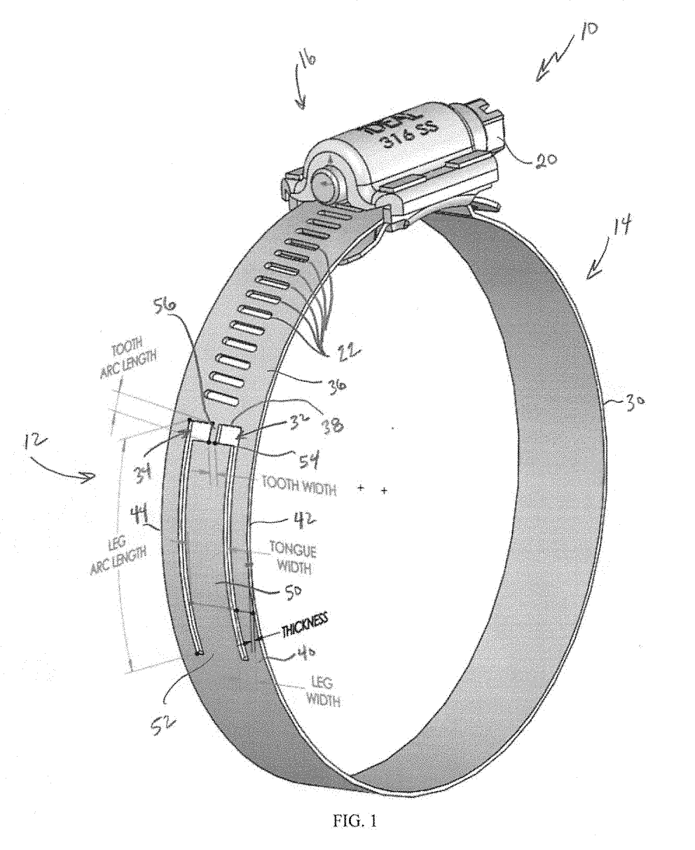

Referring now to FIG. 1, one embodiment of a hose clamp 10 including a mechanical indicator 12 is illustrated. As described in greater detail below, the mechanical indicator 12 is configured to alert an installer when proper band tension has been achieved. The hose clamp 10 includes an outer band 14 and a locking mechanism 16 configured to apply tension to the outer band 14. The clamp 10 may also include a spring liner (not shown) that is positioned within the band 14. An exemplary spring liner is shown and described in U.S. Pat. No. 8,650,719.

In the illustrative embodiment, the locking mechanism 16 is a typical screw-type tensioner that includes a screw 20 configured to engage slots 22 defined in the band 14. An end of the band 14 may be advanced into a slot defined between the tensioner 16 and the band 14 such that when the screw 20 of the tensioner is turned, the screw 20 engages the slots 22 to pull the band 14 along the slot to reduce the diameter of the clamp 10 and tighten the band 14 around the hose substrate. It should be appreciated that in other embodiments other tensioning or locking mechanisms may be used to tighten the band 14.

The outer band 14 is formed from a metallic material such as, for example, a stainless steel, titanium, aluminum, any ferrous material, and any non-ferrous material. The outer band 14 includes an elongated strip 30, and the slots 22 are defined in the strip 30. As shown in FIG. 1, the mechanical indicator 12 is formed in the elongated strip 30. In the illustrative embodiment, the mechanical indicator 12 is positioned between a pair of enclosed slots 32, 34, which are defined in the strip 30 adjacent to the slots 22 and extend circumferentially along the band 14. The slots 32, 34 divide the strip 30 into a main section 36 extending from an end 38 illustratively adjacent to the slots 22 to an opposite end 40 and a pair of legs 42, 44 extending between the ends 38, 40 of the main section 36.

The mechanical indicator 12 includes a spine 50 that extends from a base 52 attached to the end 40 of the main section 36 of the strip 30 to a tip 54. The mechanical indicator 12 also includes a tooth 56 extending between the tip 54 of the spine 50 and the end 38 of the strip 30. In the illustrative embodiment, the geometries of the legs 42,44, spine 50, and tooth 56 are selected such that the tooth 56 fractures under the strain created when proper band tension is achieved, thereby alerting the user that the clamp is properly tensioned.

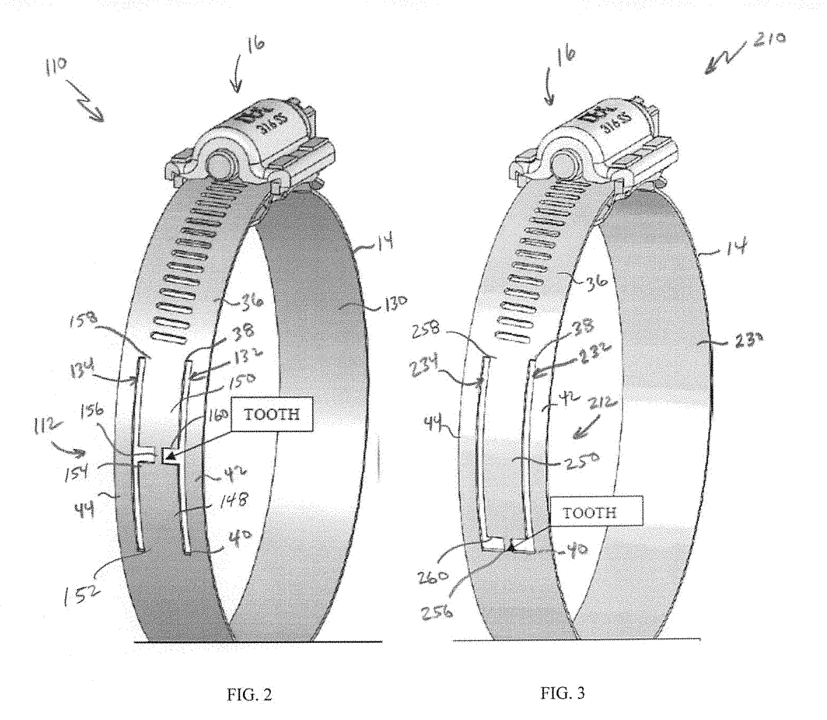

Referring now to FIGS. 2 and 3, other embodiments of hose clamps 110, 210 are shown with mechanical indicators 112, 212, respectively. The clamps 110, 210 each have a configuration similar to the configuration of the hose clamp 10, including an outer band 14 and a locking mechanism 16. As shown in FIG. 2, the mechanical indicator 112 is formed in an elongated strip 130 of the outer band 14. The indicator 112 is positioned between a pair of enclosed slots 132, 134, which are defined in the strip 130 and extend circumferentially along the band 14. The slots 132, 134 divide the strip 130 into a main section 36 extending from an end 38 illustratively adjacent to the slots 22 to an opposite end 40 and a pair of legs 42, 44 extending between the ends 38, 40 of the main section 36.

The mechanical indicator 112 includes a pair of spines 148, 150. The spine 148 extends from a base 152 attached to the end 40 of the main section 36 of the strip 30 to a tip 154. The mechanical indicator 112 also includes a tooth 156 extending from the tip 154 of the spine 148. The other spine 150 extends from a base 158 attached to the end 38 of the main section 36 of the strip 30 to a tip 160. The tooth 156 connects the tips 154, 160 of the spines 148, 150, as shown in FIG. 2.

In the illustrative embodiment, the geometries of the legs 42,44, spines 148, 150, and tooth 156 are selected such that the tooth 156 fractures under the strain created when proper band tension is achieved, thereby alerting the user that the clamp is properly tensioned.

As shown in FIG. 3, the mechanical indicator 212 is formed in an elongated strip 230 of the outer band 14. The indicator 212 is positioned between a pair of enclosed slots 232, 234, which are defined in the strip 230 and extend circumferentially along the band 14. The slots 232, 234 divide the strip 230 into a main section 36 extending from an end 38 illustratively adjacent to the slots 22 to an opposite end 40 and a pair of legs 42, 44 extending between the ends 38, 40 of the main section 36.

The mechanical indicator 212 includes a spine 250. The spine 250 extends from a base 258 attached to the end 38 of the main section 36 of the strip 30 to a tip 260. The mechanical indicator 212 also includes a tooth 256 extending from the tip 260 of the spine 248 to the end 40 of the main section 36. As with the other embodiments, the geometries of the legs 42,44, spine 250, and tooth 256 are selected such that the tooth 256 fractures under the strain created when proper band tension is achieved, thereby alerting the user that the clamp is properly tensioned

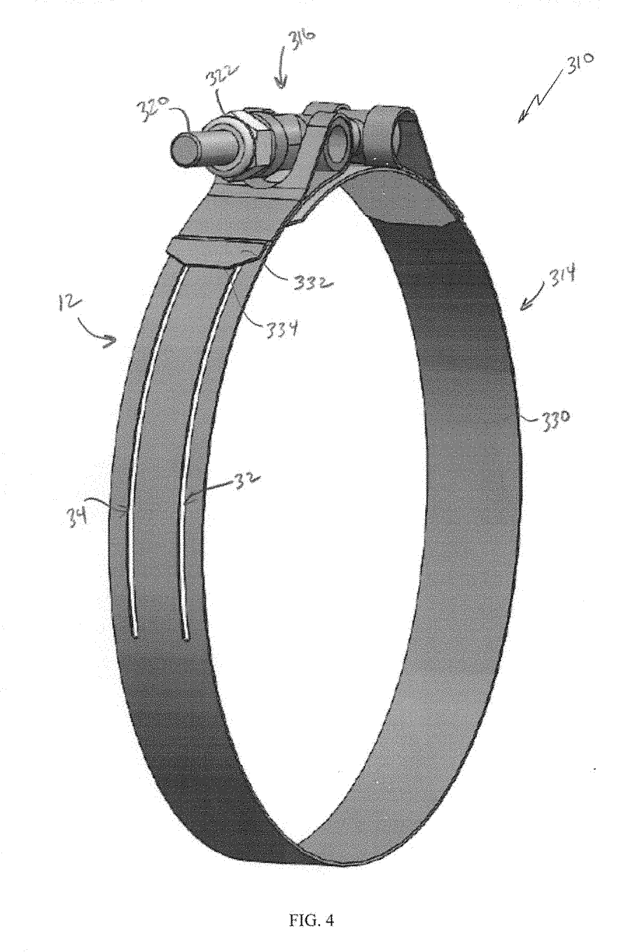

Referring now to FIGS. 4-6, another hose clamp 310 is shown with a mechanical indicator 12 similar to the mechanical indicators described above. The hose clamp 310 includes an outer band 314 and a locking mechanism 316 configured to apply tension to the outer band 314. The clamp 310 may also include a liner (not shown) that is positioned within the band 314. In the illustrative embodiment, the locking mechanism 316 is a typical T-bolt tensioner that includes a bolt 320 extending between ends of the band 314. A nut 322 is threaded onto the bolt 320 to tighten the band 314. It should be appreciated that in other embodiments other tensioning or locking mechanisms may be used to tighten the band 314.

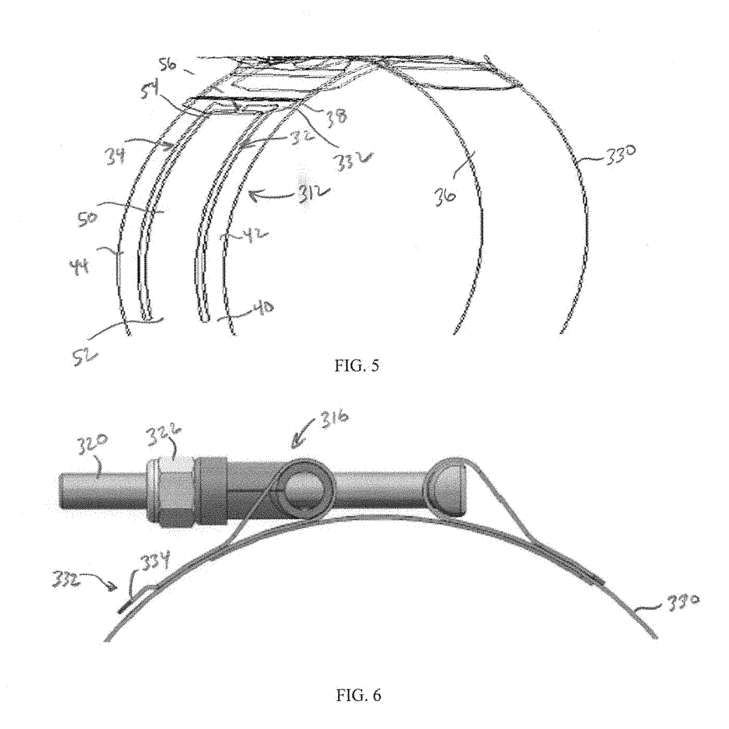

The outer band 314 is formed from a metallic material such as, for example, a stainless steel, titanium, aluminum, any ferrous material, and any non-ferrous material. The outer band 314 includes an elongated strip 330. As shown in FIG. 4, the mechanical indicator 12 is formed in the elongated strip 330. In the illustrative embodiment, the mechanical indicator 12 is positioned between a pair of enclosed slots 32, 34, which are defined in the strip 30 adjacent to the slots 22 and extend circumferentially along the band 14. As shown in FIG. 5, the slots 32, 34 divide the strip 330 into a main section 36 extending from an end 38 to an opposite end 40 and a pair of legs 42, 44 extending between the ends 38, 40 of the main section 36.

The mechanical indicator 12 includes a spine 50 that extends from a base 52 attached to the end 40 of the main section 36 of the strip 330 to a tip 54. The mechanical indicator 12 also includes a tooth 56 extending between the tip 54 of the spine 50 and the end 38 of the strip 330. In the illustrative embodiment, the geometries of the legs 42,44, spine 50, and tooth 56 are selected such that the tooth 56 fractures under the strain created when proper band tension is achieved, thereby alerting the user that the clamp is properly tensioned.

As shown in FIGS. 4-6, the band 314 also includes a guard 332 that extends over the tooth 56 to prevent debris from scattering after the tooth 56 is fractured. The guard 332 includes a plate or flange 334 that extends outwardly from the strip 330 over the tooth 56. A slot 336 is formed between the tooth 56 and the guard 332 to capture any debris.

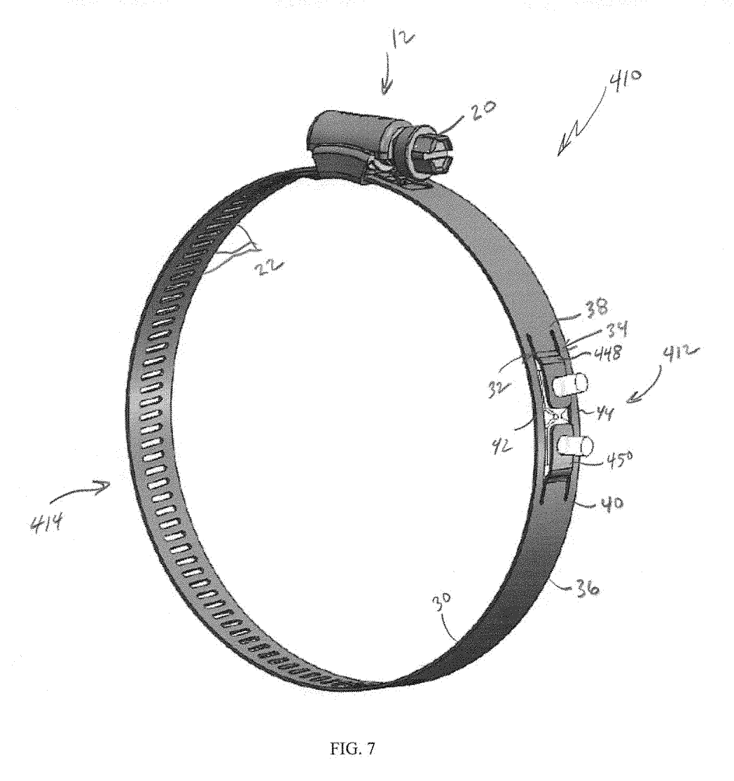

Referring now to FIGS. 7-9, another embodiment of a hose clamp 410 including a mechanical indicator 412 is illustrated. The hose clamp 410 includes an outer band 414 and a locking mechanism 16 configured to apply tension to the outer band 414. The clamp 10 may also include a liner (not shown) that is positioned within the band 414. In the illustrative embodiment, the locking mechanism 16 is a typical screw-type tensioner that includes a screw 20 configured to engage slots 22 defined in the band 414.

The outer band 414 is formed from a metallic material such as, for example, a stainless steel, titanium, aluminum, any ferrous material, and any non-ferrous material. The outer band 414 includes an elongated strip 430, and the slots 22 are defined in the strip 430. As shown in FIG. 7, the mechanical indicator 412 is attached to the elongated strip 430. In the illustrative embodiment, the mechanical indicator 412 is positioned between a pair of enclosed slots 32, 34, which are defined in the strip 430 adjacent to the slots 22 and extend circumferentially along the band 414. The slots 32, 34 divide the strip 30 into a main section 36 extending from an end 38 illustratively adjacent to the slots 22 to an opposite end 40 and a pair of legs 42, 44 extending between the ends 38, 40 of the main section 36.

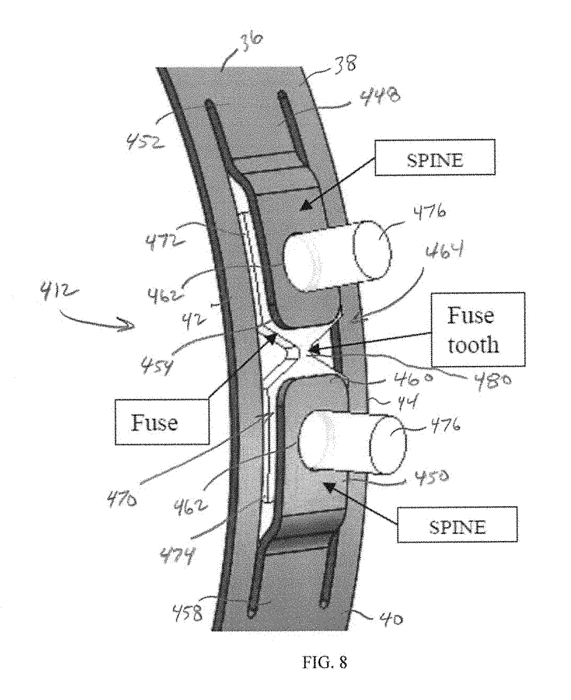

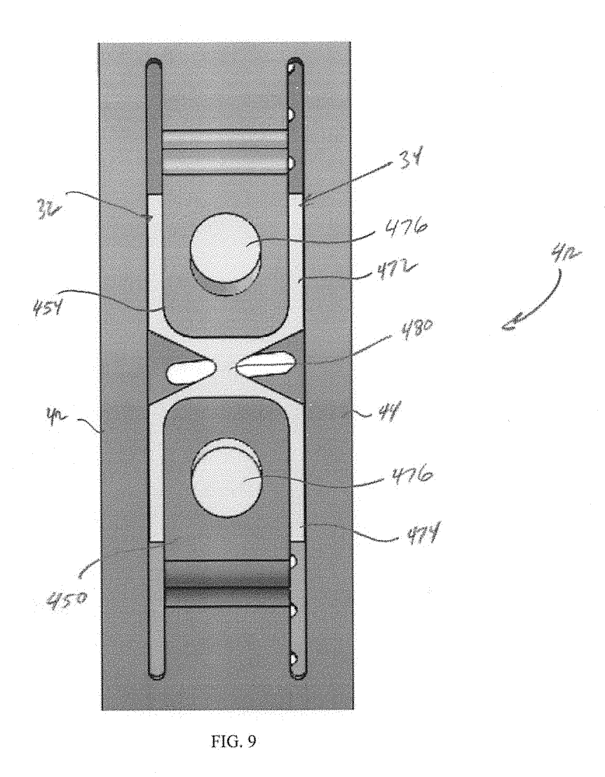

The mechanical indicator 412 includes a pair of spines 448, 450. As shown in FIGS. 8-9, the spine 448 extends from a base 452 attached to the end 38 of the main section 36 of the strip 30 to a tip 454. The other spine 450 extends from a base 458 attached to the end 40 of the main section 36 of the strip 30 to a tip 460. An opening 462 is defined in each tip 454, 460 of the spines 448, 450, and a gap 464 is defined between the tips 454, 460.

As shown in FIGS. 8-9, the mechanical indicator 412 includes a fuse 470 positioned radially inward from the spines 448, 450. In the illustrative embodiment, the fuse 470 is formed from a polymeric material such as plastic. The fuse 470 includes a plate 472 positioned radially inward from the spine 448 and another plate 474 positioned radially inward from the spine 450. A stud 476 extends radially outward from each of the plates 472, 474 and is received in a corresponding opening 462 of each spine 448, 450.

The fuse 470 also includes a tooth 480 that connects the plates 472, 474 in the gap 464 defined between the spines 448, 450. In the illustrative embodiment, the geometries of the legs 42,44, spines 448, 450, and tooth 480 are selected such that the tooth 156 fractures under the strain created when proper band tension is achieved, thereby alerting the user that the clamp is properly tensioned.

As shown, the fuse 470 is attached to the band 414 thru hot-staking; it is important to note the fuse can be made from any material and adhered to the spines 448, 450 spanning the gap 464 in other ways. As shown, the fuse 470 is adhered below the spines. In other embodiments, the fuse may be positioned in other orientations as long as the fuse spans the gap between the spines and is positioned to channel the strain thru the fuse tooth.

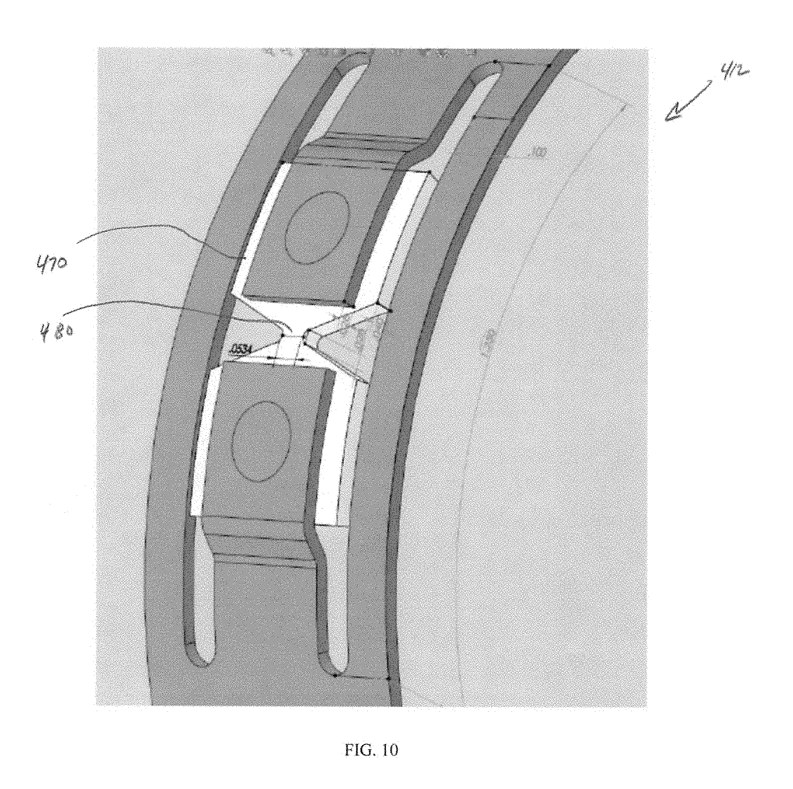

In the illustrative embodiment, the critical variables are the leg width, thickness, arch length, and material properties; and the fuse length, thickness, width and material properties. Exemplary dimensions for the dimensions are shown in FIG. 10. All dimensions are in inches. The plastic for the fuse 470 has an elongation of 10% and a tensile strength of 7.6 ksi. The band (leg) material is 301SS 1/2 hard material with an elongation of 15% min and a tensile of 160 to 190 ksi. The fuse in this system is designed to break at about 800 lbs of band tension. It should be noted that the band tension break point of about 800 lbs is exemplary. In other embodiments, the band tension break point may be dependent of an application of the hose clamp 10. In some embodiments, about 800 lbs means 800 lbs±20 lbs. In some embodiments, about 800 lbs means 800 lbs±50 lbs. In some embodiments, about 800 lbs means 800 lbs±100 lbs.

The embodiments described above attach clamps to hose substrates such that a desired radial, axial and circumferential position relative to the substrate outer diameter and hose end is maintained. The systems illustratively permit circumferential movement of the clamp band relative to the underlying hose by means of an eyeletted slide and multiple configurations of fixation retainers. It will be appreciated that the devices and methods described herein have broad applications. The foregoing embodiments were chosen and described in order to illustrate principles of the methods and apparatuses as well as some practical applications. The preceding description enables others skilled in the art to utilize methods and apparatuses in various embodiments and with various modifications as are suited to the particular use contemplated. In accordance with the provisions of the patent statutes, the principles and modes of operation of this disclosure have been explained and illustrated in exemplary embodiments.

It is intended that the scope of the present methods and apparatuses be defined by the following claims. However, it must be understood that this disclosure may be practiced otherwise than is specifically explained and illustrated without departing from its spirit or scope. It should be understood by those skilled in the art that various alternatives to the embodiments described herein may be employed in practicing the claims without departing from the spirit and scope as defined in the following claims.

What is claimed is:

1. A hose clamp comprising:
an annular band,
a tension mechanism configured to tighten the annular band to increase band tension, and
a mechanical indicator configured to fracture at a predetermined band tension.

2. The hose clamp of claim 1, wherein the mechanical indicator comprises a tooth connected to a spine, the tooth being configured to fracture at the predetermined band tension.

3. The hose clamp of claim 2, wherein the mechanical indicator comprises a fuse coupled to the spine, the fuse including the tooth.

4. The hose clamp of claim 2, wherein the tooth is formed from a plastic material and the annular band is formed from a metallic material.

5. The hose clamp of claim 2, wherein the annular band includes the spine.

6. The hose clamp of claim 2, wherein the annular band includes a pair of spines, and the tooth extends between the pair of spines.

7. The hose clamp of claim 2, wherein the annular band includes the spine and the tooth.

8. The hose clamp of claim 1, wherein the predetermined band tension is equal to about 800 lbs.
